(19) United States
(12) Patent Application Publication
(10) Pub. No.: US 2012/0164427 A1
(43) Pub. Date: Jun. 28, 2012

(54) MUMs (Multi Use Mats)

(76) Inventor: Karen Mary Hudson, Albuquerque, NM (US)

(21) Appl. No.: 13/048,079

(22) Filed: Mar. 15, 2011

(51) Int. Cl. B32B 5/00

(52) U.S. Cl. 428/221

(57) ABSTRACT

MUMs (Multi Use Mats) are exactly what the name implies. MUMs can be used for multitude of uses. Biodegradable, disposable, self-contained mats.

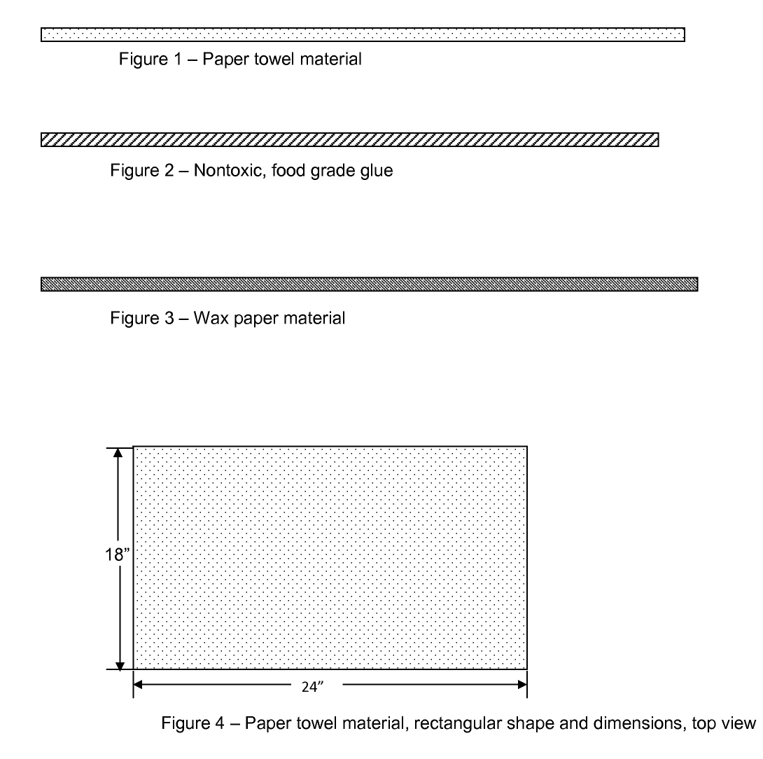

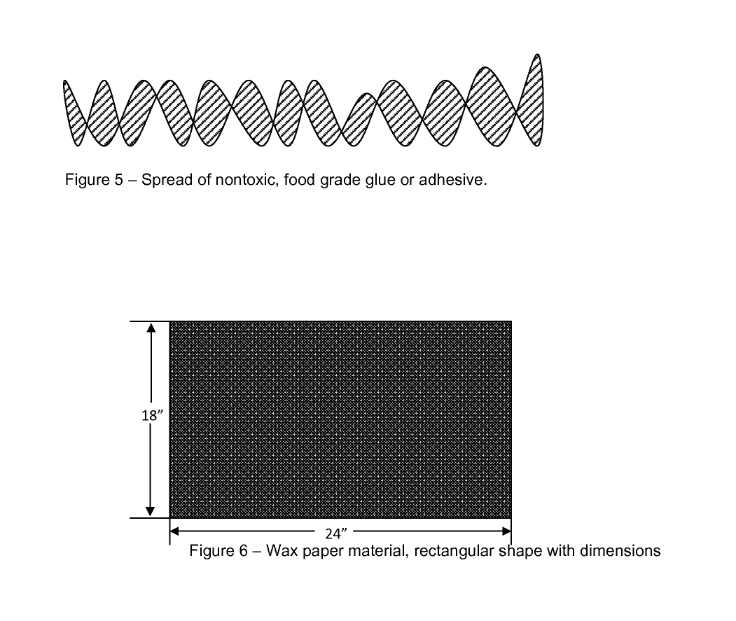

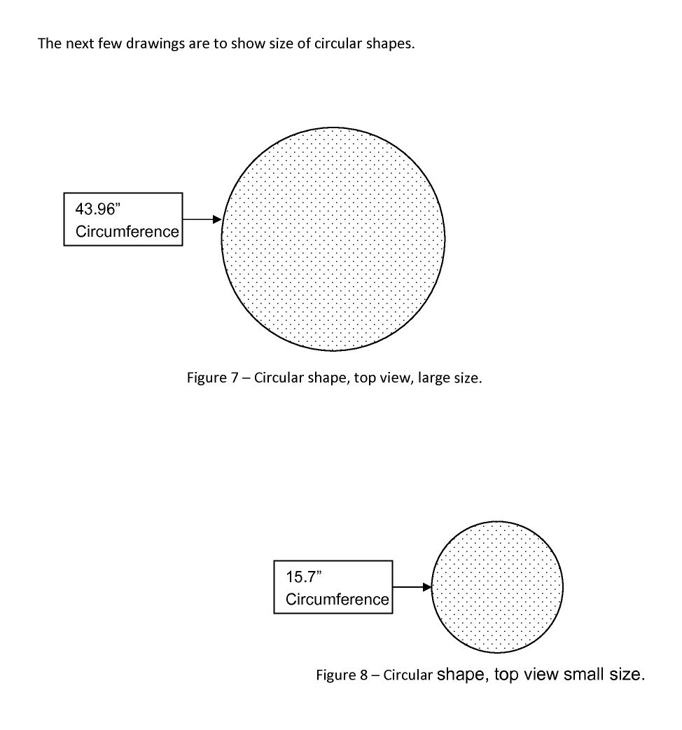

### CROSS REFERENCE

| Pat. No. | Title | Issue date |
|---|---|---|
| D180026 | (unknown) | April 1957 |
| D181205 | (unknown) | October 1957 |
| D386620 | Embossed paper toweling | Nov. 25, 1997 |
| D391400 | Paper towel | Mar. 3, 1998 |
| D409000 | Pattern for an embossed paper product | May 4, 1999 |
| D422150 | Surface pattern for a paper towel | Apr. 4, 2000 |
| | or toilet tissue | |
| D430407 | Pattern for absorbent sheet material | Sep. 5, 2000 |
| D431372 | Pattern for absorbent sheet material | Oct. 3, 2000 |
| D441541 | Paper towel | May 8, 2001 |
| D449453 | Surface pattern for paper product | Oct. 23, 2001 |
| D450934 | Paper product | Nov. 27, 2001 |
| 6,344,111 | Paper tissue having enhanced | Feb. 5, 2002 |
| | softness | |
| D453421 | Embossed paper | Feb. 12, 2002 |
| 6,423,397 | Embossed absorbent paper sheet | Jul. 23, 2002 |
| D464202 | Composite fabric panel for a | Oct. 15, 2002 |
| | disposable article | |
| D465094 | Surface pattern for embossed | Nov. 5, 2002 |
| | paper product | |
| 6,827,819 | Soft bulky multi-ply product | Dec. 7, 2004 |
| D501089 | Paper product | Jan. 25, 2005 |
| 3,376,244 | (unknown) | April 1968 |
| 3,767,444 | (unknown) | October 1973 |
| 4,235,641 | Dyeing agent compositions based on | Nov. 25, 1980 |
| | polypropylene wax | |
| 4,380,565 | Color preservation of wax-coated | Apr. 19, 1983 |
| | paperboard | |
| 4,820,876 | Polyethylene wax | Apr. 11, 1989 |
| 2,829,054 | THE RESULTING PRODUCT | 1958 |
| 3,094,947 | SUGAR-COATING PROCESS | 1963 |
| 3,134,677 | PARTIALLY HYDROLYZED | 1964 |
| | ROASTED SESAME | |
| 3,365,299 | RICE PRODUCT AND PROCESS | 1968 |
| 3,740,236 | PARTIALLY DEFATTED NUT | 1973 |
| | COATING AND RECONSTITUTING | |
| | PROCESS | |
| 3,850,838 | DISPERSIBILITY OF | 1974 |
| | WATER-SOLUBLE GUM | |
| 4,692,478 | Process for preparation of resin | Sep. 8, 1987 |
| | and resin obtained | |
| 4,842,610 | Depilatory compositions and methods | Jun. 27, 1989 |
| 4,981,707 | Dextrin-based food-grade adhesive | Jan. 1, 1991 |
| | including xanthan or | |
| | carboxymethyl cellulose or mixtures thereof | |
| 5,827,553 | Edible adhesive | Oct. 27, 1998 |
| 6,428,561 | Biocompatible glue | Aug. 6, 2002 |

MUMs are a product that is very simple in design and making. It consists of and absorbent paper (like a paper towel) food grade adhesive and wax paper. The papers used are biodegradable, ample sizes and various shapes, the adhesive or glue is non-toxic, food grade.

The making or producing of this product, MUMs, can be made by a paper company that is able to convert the two main items, paper towel material and wax paper material and fuse or glue them together.

MUMs have many, many uses; Food—preparing of poultry and other foods that can leave salmonella or other bacteria on surfaces. MUMs is “self-contained” in that, you prepare the food on the MUMs, without having the wetness or juices sink through the absorbent side to the surface, the wax paper stops the wetness from soaking through and causing bacteria to contact the surface. Also, after washing vegetables and fruits for air drying. And, placing baked goods on the wax side up, with the absorbent side down on the surface creates and insulation from the heat of the baked food for cooling. Or, place hamburgers or other greasy grilled foods on the MUMs to wick the grease away or off of the grilled foods.

Other kitchen or dining applications—MUMs can be used as placemats for children, because children are messy eaters. Also one can put watery fruits and vegetables on it as a snack mat, like watermelon or grapes, MUMs absorbs the liquid and prevents it from contact with any surface. Or, placemats for regular dining in household use and commercial use. They can also be used as microwave mats to prevent overspill from heated foods. If placed atop a bowl, either side, it can prevent splatter from cooking in the microwave. Put in the refrigerator shelf or drawer as a liner. Then just replace MUMs with fresh MUMs.

Plants—MUMs can be placed under potted plants, again absorbing overflow of watering preventing the liquid from contacting a surface, or, wrapping a cutting or just cut flowers or plants to keep the roots moist until plants or flowers are placed in a garden or container. MUMs comes in various shapes and sizes.

Messy creations—MUMs can be used as mats for children or adult crafts, to keep surfaces from moisture contact, being self-contained, cleanup would be easy.

Health and Beauty—MUMs can be used in salons, to lie hair and make-up on and dispose of after beauty professional has finished with customer, thus keeping the work station sanitary. For the home, a person can lay MUMs on a counter or in a sink to put beauty product on while applying products. Then dispose of.

Dental and Medical Use—commercial applications for the medical industry, dentists can lay dental instruments upon the MUMs then dispose of the MUMs, again the wax paper prevents moisture from contact to a surface for a more hygienic surface. Hospitals can use MUMs for placemats under food trays or on the food tray, when the patient is done, the MUMs, being self-contained, can be disposed of according to hospital regulations, reducing the chance for whatever illness to spread.

Some MUMs will be small enough in size to be used as large coasters. Use MUMs to air dry baby items that have been disinfected.

What I claim as my invention is:

1. MUMs (Multi Use Mats), the mats consist of the materials stated in the specification, and address the issues in the background section. Used in normal everyday activities not only for one purpose, but many.
